(19) United States
(12) Patent Application Publication
(10) Pub. No.: US 2022/0270046 A1
(43) Pub. Date: Aug. 25, 2022

(54) Systems And Methods Of Training A Machine Learning Model

(71) Applicant: Portage Insurance Holdings, Inc., Lake Forest, IL (US)

(72) Inventors: John Richard Burge, Hermosa Beach, CA (US); Jonathan Polon, Toronto (CA)

(21) Appl. No.: 17/681,400

(22) Filed: Mar. 4, 2022

Related U.S. Application Data
(60) Provisional application No. 63/153,465, filed on Feb. 25, 2021.

(51) Int. Cl. G06Q 10/10; G06N 20/00

(52) U.S. Cl. CPC G06Q 10/10; G06N 20/00

(57) ABSTRACT

One or more machine learning models are trained using data from disparate data training sets. Of particular interest are training sets relating to dispute resolution, and more particularly industry data and carrier data training set relating to insurance claims. The various data sets are used to produce machine learning models of varying fidelity, in which in which the amounts of known feature data range from more complete to less complete. Viewed from another perspective, the inventive subject matter also includes a computer-based predictive modeling system, in which a processor executes a predictive model, comprising multiple nodes and edges, in which some of the nodes store data relating to fixed modeling parameters, some of the nodes store data relating to variable modeling parameters, and some of the nodes store predicted outcomes. Prediction fitness scores are generated for various outcomes, and outcomes can be optimized by iterating the nodes with different models, and by iterating the weightings applied to the different outcomes.

This application claims priority to U.S. provisional application Ser. No. 63/153465, filed Feb. 25, 2021. The priority application and all other referenced extrinsic materials are incorporated herein by reference in their entirety. Where a definition or use of a term in a reference incorporated by reference is inconsistent or contrary to the definition or use of that term herein, the definition or use of that term provided herein is deemed to be controlling.

The field of the invention is machine learning, and more particularly methods of training machine learning models.

### BACKGROUND

Machine learning models (variously referred to as machine learning models or systems, artificial intelligence, or AI) are typically trained by providing a model with a large set of correlation data.

A significant problem with training machine learning models is bias in the training data. For example, use of Northern European faces to train a machine learning model to recognize individuals tends to do poorly in recognizing Southern hemisphere individuals. An obvious solution is to broaden the training data to include a secondary data set comprising faces of Southern hemisphere individuals. But that only works if the broadening training data is compatible with the primary training data. In the face-name example above, a machine learning model trained with primary data that correlates facial images and names would be difficult to train with a secondary data set that correlates facial images with occupations or ages, but not names. In the vernacular used herein, training data sets with inconsistent features are considered to be “disparate”.

Disparity of training set date is particularly difficult in the field of insurance claims, where the relevant data sets are highly disparate. For example, the National Practitioner Data Bank correlates age, severity, allegations and practitioner type to payment amounts, but not to claim outcome probabilities, while Verdict Reporting data sets typically correlate state, judge, court, attorneys and nature of injury to trial outcomes and payments only, and a state Insurance Department Closed Claim Report may only correlate medical specialty, allegation and severity to payment amounts and expense amounts, but not to claim outcomes. Moreover, one cannot adequately resolve the disparity by limiting the training to only a few data sets that correlate a small number of relevant features. In med mal cases, for example, relevant predictive features include all of the following:

Medical specialty
Treatment area
Allegation
Injury severity
Projected future care required
Plaintiff credibility
Plaintiff attorney win/loss record
Defense attorney win/loss record
Venue where case is filed
Judge assigned to the case

These disparity problems are further complicated by the fact that some of the predictive features require time and resources to understand and assess, which tends to happen in parallel with decisions that are being made by the various participants. As a result, decisions are often being made based on incomplete knowledge of the predictive features. Additionally, while some of the predictive features are fixed, others may change over time, and some are necessarily based on professional or expert judgment and may not be comparable against prior disputes for benchmarking purposes. As meaningful benchmarking becomes harder, uncertainty rises, and the participants have a harder time predicting each other's behaviors. As a result, disputes require a lot more resources to resolve, and take a lot more time to resolve, resulting in greater elapsed time before resolution, and/or excessive transaction costs.

Thus, known methods of training machine learning models run into technical limitations where:
Data sets are of insufficient size or scope to build, accurate, valid predictive models;
Predictive features are spread across disparate datasets that are not readily combinable;
Knowledge of the predictive features is incomplete;
Predictive features change over time; and
Predictive features are based on professional or expert judgment.

Accordingly, there is a need in the art for methods of training machine learning models in complex fields such as dispute resolution, and especially in valuation and resolution of insurance claims.

### SUMMARY OF THE INVENTION

The inventive subject matter provides apparatus, systems, and methods in which a machine learning model is trained by:
Instantiating in a memory at least first and second disparate training data sets, which correlate disparate features with outcome attributes;
Producing a common feature data set that correlates at least one common feature with the outcome attributes;
Producing additional data sets that correlate individual features with the outcome attributes;
Applying regression modeling to the additional data sets to produce adjustment factors; and
Using at least the common feature data set and the adjustment factors to train a machine learning model.

In the field of insurance claims, it contemplated that the relevant features include injury, age, gender, venue, person identities, medical expenses, lost wages, future care, judgments of liability, causation, and credibility, and outcome attributes include monetary and probability outcomes. Among other things, outcome models can be used to guide dispute resolution strategies, value portfolios of claims, identify areas of bias such valuations, estimate valuations in which historical data is lacking, and set aside reserves.

In preferred embodiments, the various data set are used to produce machine learning models of varying fidelity, in which in which the amounts of known feature data range from more complete to less complete.

Viewed from another perspective, the inventive subject matter also includes a computer-based predictive modeling system, in which a processor executes a predictive model, comprising multiple nodes and edges, in which some of the nodes store data relating to fixed modeling parameters, some of the nodes store data relating to variable modeling parameters, and some of the nodes store predicted outcomes. Prediction fitness scores are generated for various outcomes, and outcomes can be optimized by iterating the nodes with different models, and by iterating the weightings applied to the different outcomes.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is an ecosystem diagram of disparate datasets related to dispute resolution.

FIG. 2 shows a schematic of a computing system connected to end users through a network.

FIG. 3 is a block diagram of an outcome prediction system.

FIG. 4A shows dispute data, and FIG. 4B personal judgment data.

FIG. 5A shows a table in a predictive model database, 5B illustrative outcomes and 5C illustrative outcome variables.

FIG. 6 shows an illustrative mapping across graph nodes.

FIG. 7 shows an example reconciliation model.

FIG. 8 depicts a model scope lookup table.

FIG. 9 is an illustration of how the scope of a predictive model can be expanded.

FIG. 10 is an illustrative outcome graph.

FIG. 11 is a user interface for interacting with the outcome prediction system.

FIG. 12 is an illustrative visualization of an outcome graph.

FIG. 13 is a table of aggregated outcome values.

FIG. 14 depicts an outcome prediction process.

FIG. 15 depicts the triggers for automatically re-running/updating outcome models.

FIGS. 16A and 16B depict processes for users to manually override model results, based on personal knowledge.

FIG. 17 depicts a personal judgment updating process.

FIG. 18 depicts a predictive model scope selection process.

FIG. 19 depicts unknown predictive attributes to vary for assessing variability.

FIG. 20A is a variability analysis process and FIG. 20B an illustrative output of the variability analysis process.

FIG. 21 is a schematic of an exemplary embodiment in which data from disparate data sets are coordinated to provide training data to a machine learning model.

FIG. 22 is a schematic of an exemplary embodiment in training data from disparate data sets are used to produce machine learning models of various predictive fidelity, and to estimate areas of bias.

### DETAILED DESCRIPTION

The following description provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be noted that the above-described invention relates to a computing system connected to a network. The computing system may include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The computing and network systems which support this invention are more fully described in the patent applications referenced within this application.

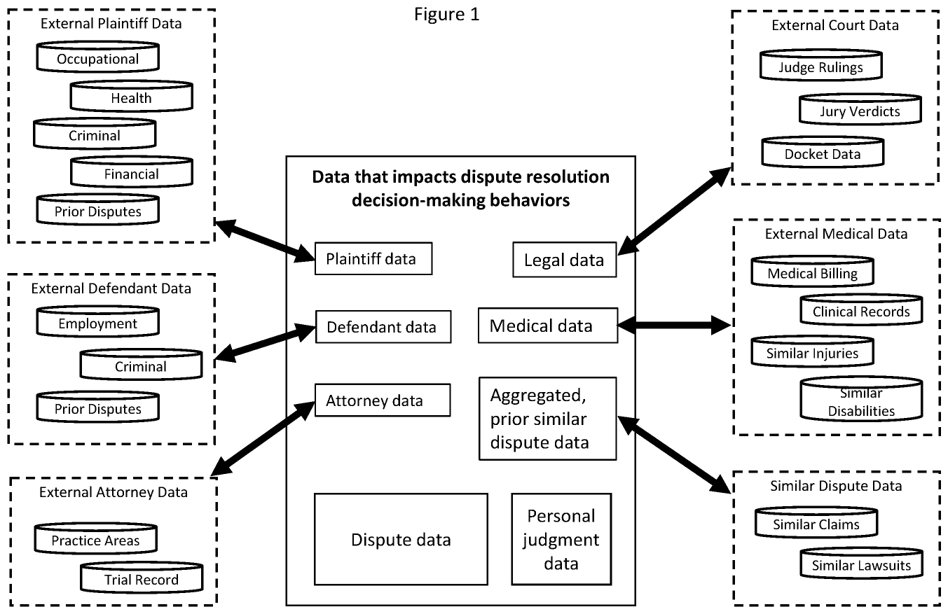

FIG. 1 is an illustrative ecosystem diagram of the disparate datasets containing attributes that can predict dispute resolution decision-making behaviors. This data can include external data about the plaintiff, defendant, attorneys involved in the matter, judge and venue data, medical data and data about the resolution of similar disputes.

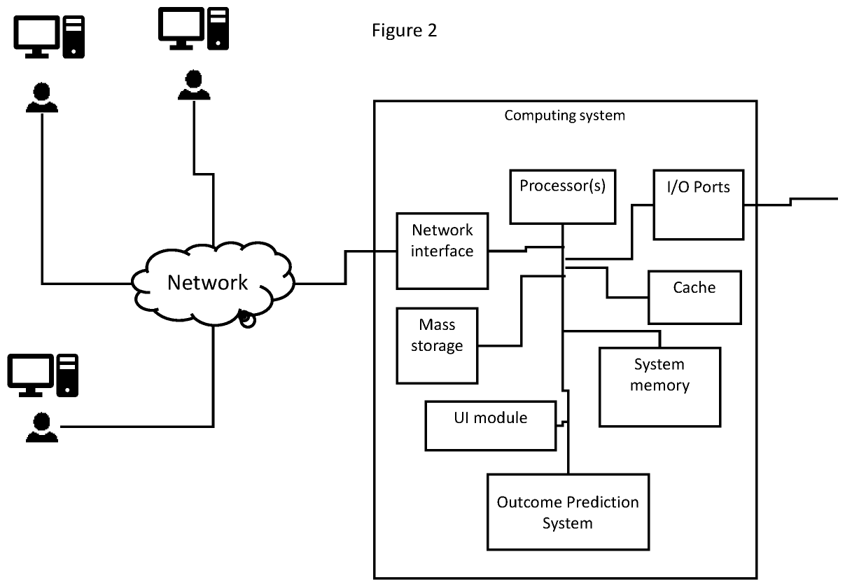

FIG. 2 illustrates a schematic of a computing system of some embodiments, here shown connected to end users through a network, and including one or more processors, a network interface, mass storage, cache, system memory, I/O ports and an outcome prediction system. The network interface communicates with computing devices over a network. Network could be the Internet, a virtual private network, corporate network or any network known in the art for enabling computer networking across a collection of computer users. Computing devices are shown here as portable computers, but could be tablets, smartphones, laptops, wearable devices or any computing device known in the art capable of communicating over a network. Users behind the computing devices interact with insight data objects through the UI module of the computing system.

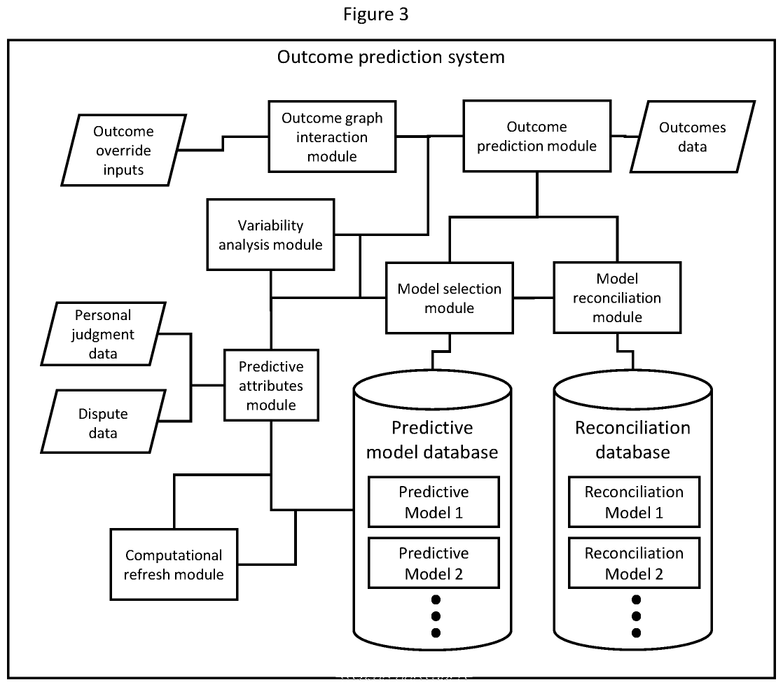

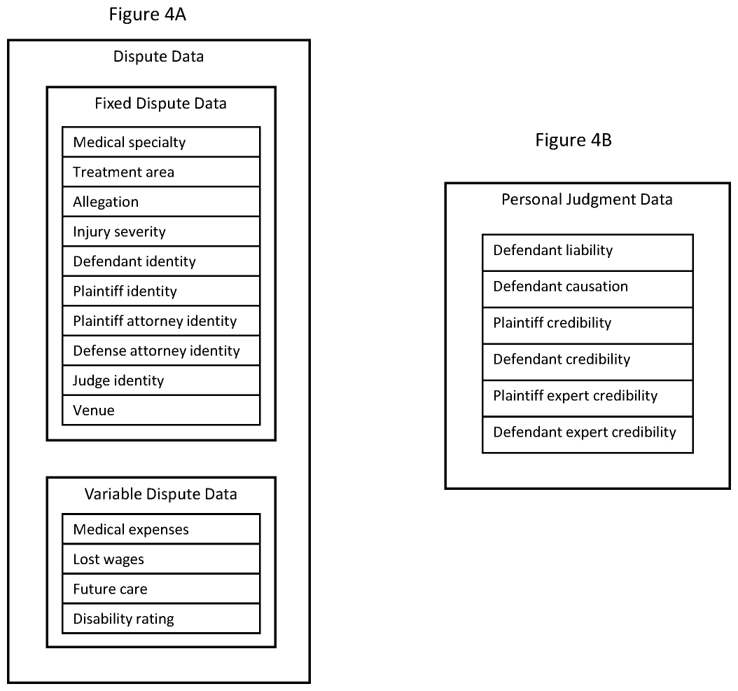

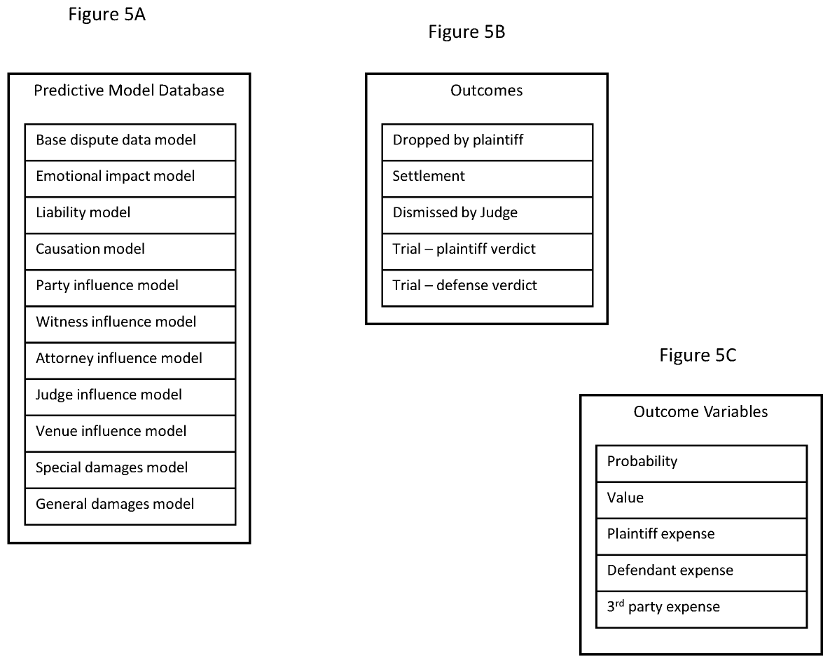

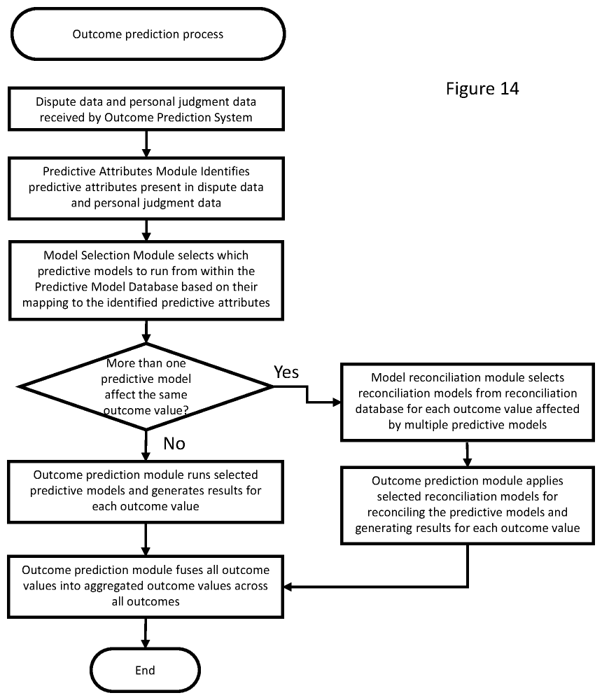

FIG. 3 is a block diagram illustrating one embodiment of an outcome prediction system. The outcome prediction system is shown with inputs including dispute data, personal judgment data and outcome override inputs. An example data table of dispute data is shown in FIG. 4A as including fixed dispute data and variable dispute data. Dispute data can be facts and data about a lawsuit, insurance claim or other form of dispute. An example data table of personal judgment data is shown in FIG. 4B. Personal judgment data can be the personal judgments of attorneys, experts, insurance claim adjusters, judges, jurors, arbitrators, witnesses or any other human about various facts or issues relevant to the dispute. The outcome prediction system includes a predictive attributes module, in communication with a predictive model database, which identifies dispute data and personal judgment data that matches with predictive attributes in one or more predictive models found in the predictive model database. Predictive models can be just about any form of mathematical operation known in the art for quantifying the influence of a predictive attributes, including numeric factors, equations and algorithms. An example of predictive models that may be found in the predictive model database is shown in FIG. 5A. Model selection module uses the predictive attributes to select the models to be run from the predictive model database. FIG. 14 is a process diagram that describes the model selection process, including interaction with the model reconciliation module also shown in FIG. 3.

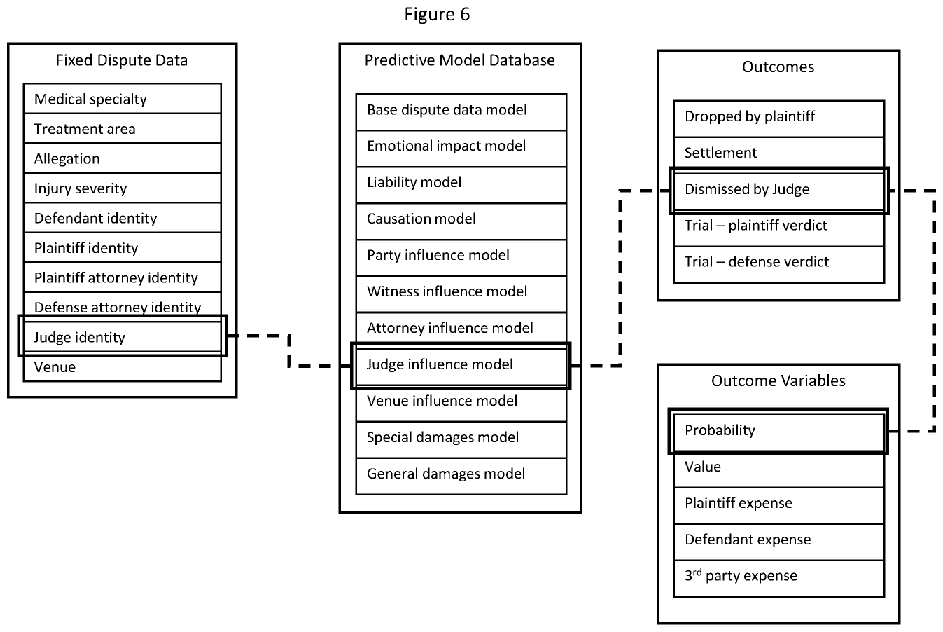

As illustrated in FIGS. 5B, 11, 12 and 13, there are multiple potential outcomes for a given dispute. A dispute can be dropped by the initiator of the dispute, such as a plaintiff or a plaintiff attorney. A dispute could also be dismissed by a judge, have a verdict rendered by a jury or be resolved by a settlement between the disputing parties. As illustrated in FIG. 5C, there are multiple outcome variables that can characterize a potential outcome of a dispute, including the probability of that outcome, value of the outcome and expenses incurred by the plaintiff, defendant or a third party such as a court system. As illustrated in FIGS. 5B, 11, 12 and 13, the present invention provides a system for enabling each of these outcomes, and more specifically the outcome variables for these potential outcomes, to be predicted individually by using individual models which map to them based on predictive attributes which influence them. An illustrated mapping is shown in FIG. 6, shown as a predictive attribute within dispute data (judge identity) that is utilized in a predictive model (judge influence model), that influences a potential outcome (dismissed by judge), and specifically the probability value of the dismissed by judge outcome.

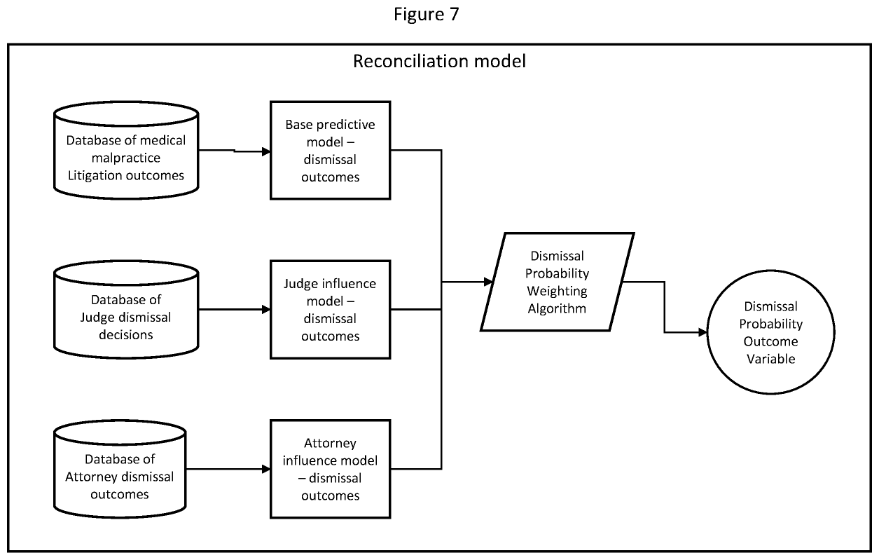

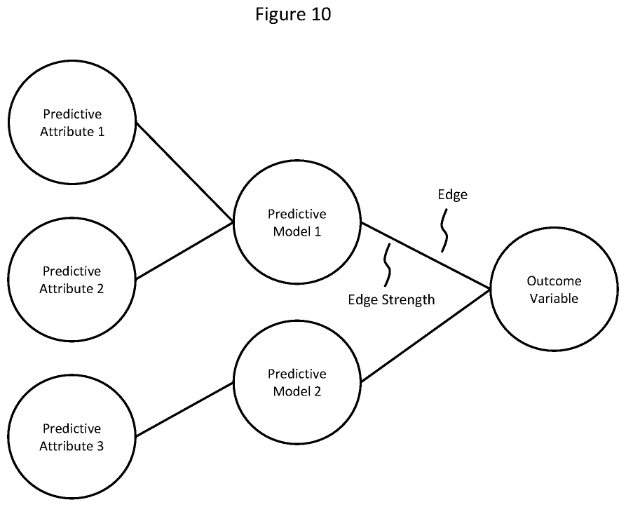

As shown in FIGS. 7 and 10, more than one predictive attribute may influence a specific outcome value, requiring the reconciling of the results of multiple predictive models which are selected by the model selection module shown in FIG. 3. As shown in FIG. 3, the outcome prediction system includes a model reconciliation module in communication with a reconciliation database containing one or more reconciliation models. FIG. 7 depicts an illustrative reconciliation model for reconciling the results of multiple models when more than one model influences an outcome attribute. As shown in FIG. 7, multiple predictive models may affect an outcome that are based on different, disparate databases. Reconciliation models can be just about any form of mathematical operation known in the art for reconciling the results of two models, including weighting factors, equations and algorithms. FIG. 14 is a process diagram illustrating the operation of the model selection module and model reconciliation modules in selecting the appropriate predictive models, reconciling them when multiple models affect an outcome value and fusing them to derive aggregated outcome values across the potential outcomes. This latter function is performed by outcome prediction module show in FIG. 3.

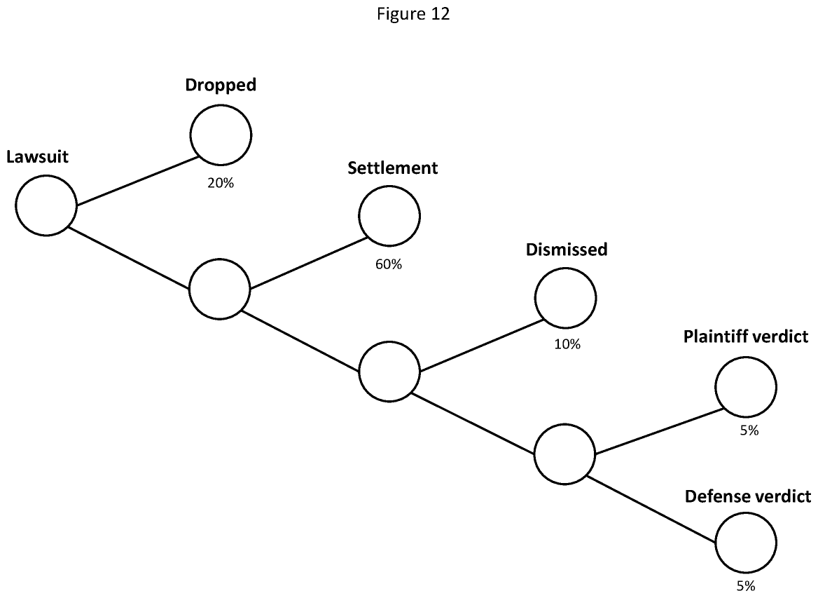

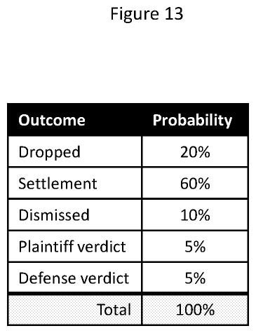

Outcome prediction module generates a graph of the relationships illustrated in FIG. 6. As shown in FIG. 10, the graph consists of nodes, edges and edge strength, where nodes can be outcome values, outcomes, predictive models and predictive attributes. The edges represent the relationships that each of these have, with edge strength reflecting their influence on the connected nodes. A simplified way to present the outcome and outcome value nodes in the graph is illustrated in FIG. 12 in the form of an acyclic, directed graph. This is just one example of how the outcome attributes from the outcome models can be combined and visualized via an end-user display, while hiding the complexity of the underlying relationships to predictive models and predictive attributes. An example of aggregated outcome values from the outcome prediction model is shown in FIG. 13, shown as probability values for each potential dispute resolution outcome.

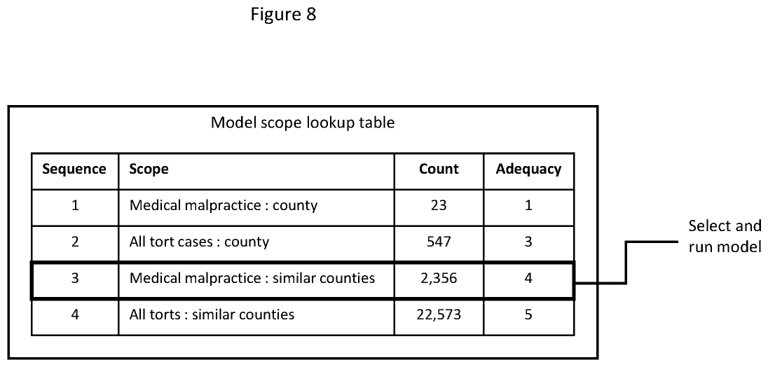

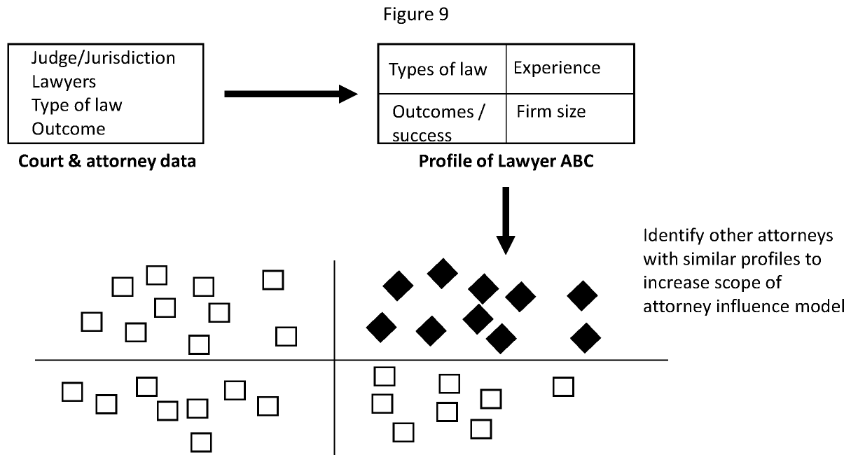

As shown in the model scope lookup table depicted in FIG. 8, models may have more than one scope associated with them. For some sets of dispute data, the models that match up with the predictive attributes may not have large enough datasets behind them to possess adequate predictive power. As described in the process shown in FIG. 8, model scope lookup table is used to select the scope of a given predictive model that has adequate predictive power, here shown as a model scope with an adequacy rate of greater than 3. There are numerous ways to expand the scope of models that lack predictive power, including the identification and scoring of similar predictive attributes, as shown by the grouping of attorneys with similar profiles in FIG. 9. FIG. 9 also shows that output from a predictive model can then be used as input for the next sequential predictive model

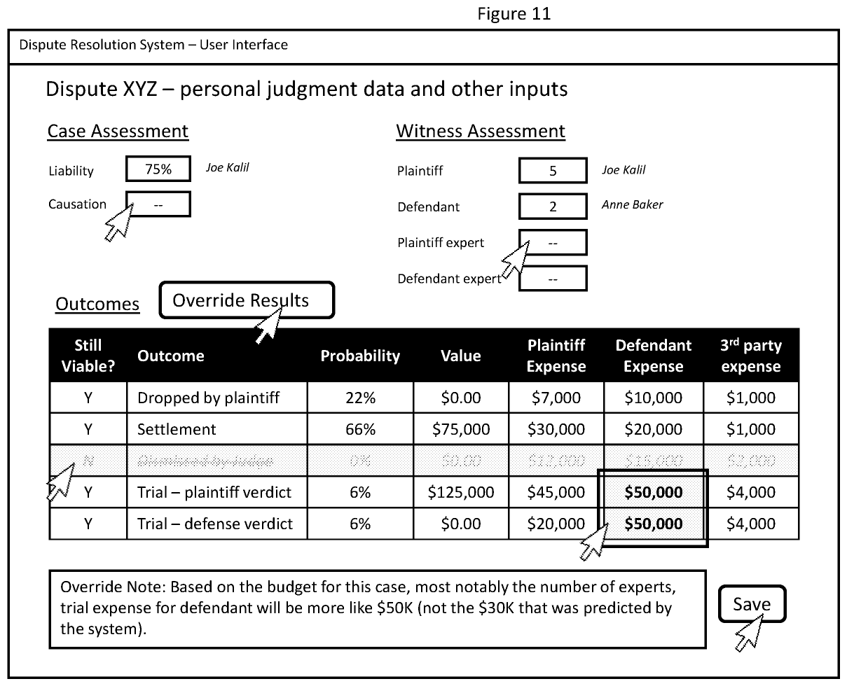

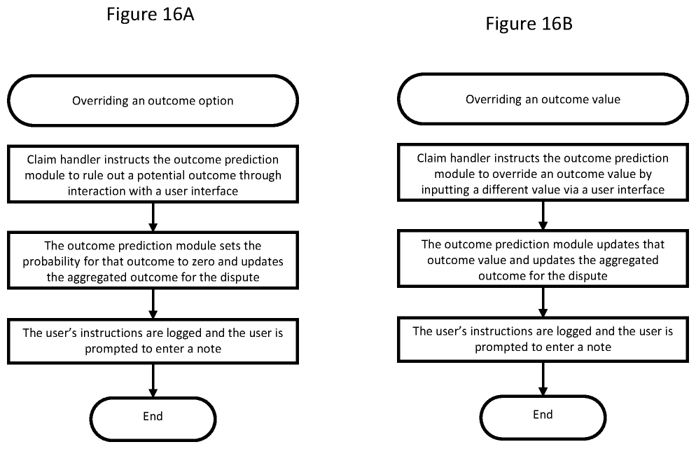

As illustrated in FIG. 11, end users can interact with the outcome prediction system. They can input personal judgment data as shown in the interface in FIG. 11 as shown in the ‘case assessment’ and ‘witness assessment’ sections of the interface. They can also override the results of the outcome prediction system. The process for overriding an outcome option is described in FIG. 16A, and is illustrated from the system user standpoint in FIG. 11. By clicking on the ‘override results’ button, the user can change the value in the first column by entering a different value—here shown as changing a Y to a N for whether the ‘dismissed by judge’ outcome is still a viable outcome. Note that this has the effect of excluding this potential outcome from the aggregated outcome values as shown in FIG. 13, triggering re-running of the affected predictive models, reconciliation models and aggregate outcome model. Users can also override outcome values as shown in FIG. 11 where the user has changed the defendant expense values for the outcomes related to ‘trial—plaintiff verdict’ and ‘trial —defense verdict.’ The process of overriding outcome values is described in FIG. 16B. The user interface of FIG. 11 further provides for a user feedback system for users who override the outcome options or outcome values generated by the outcome prediction system. This feedback information can be collected for tuning of the models.

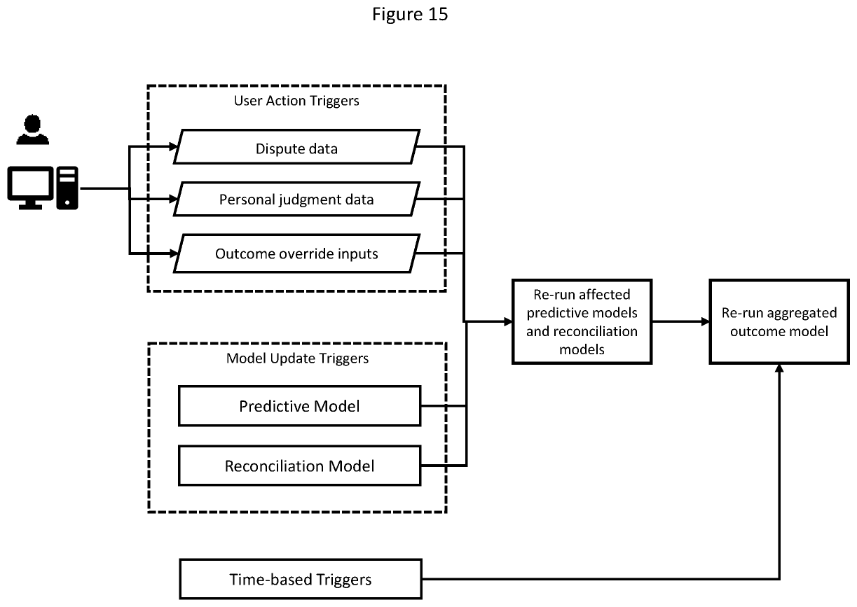

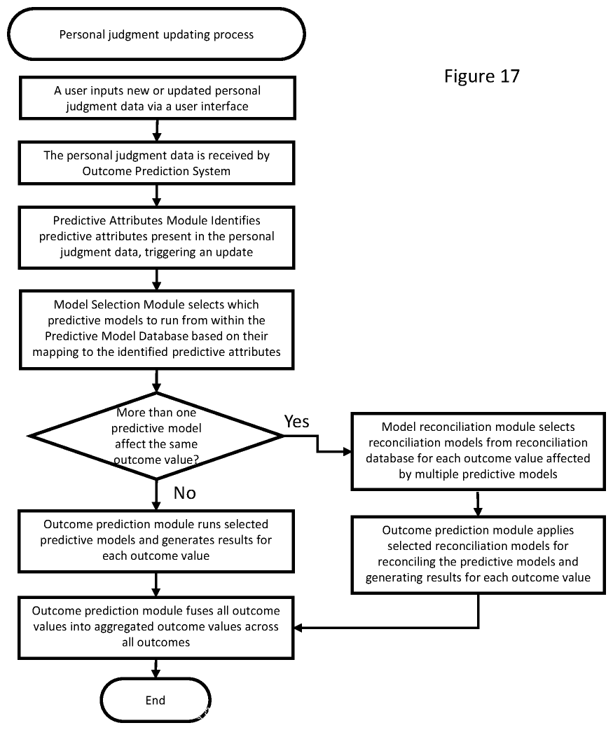

As shown in FIG. 15, there are multiple ways to automatically trigger updating of the outcome prediction system results, including time-based triggers, triggers to update when a predictive model or reconciliation model is updated, and other user action triggers including inputting of personal judgment data. The process of updating the outcome prediction system results is illustrated in FIG. 17.

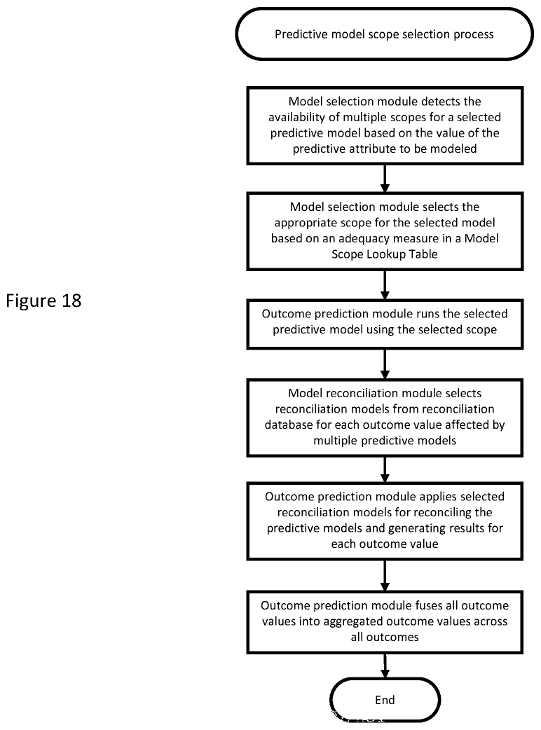

FIG. 18 depicts a predictive model scope selection process

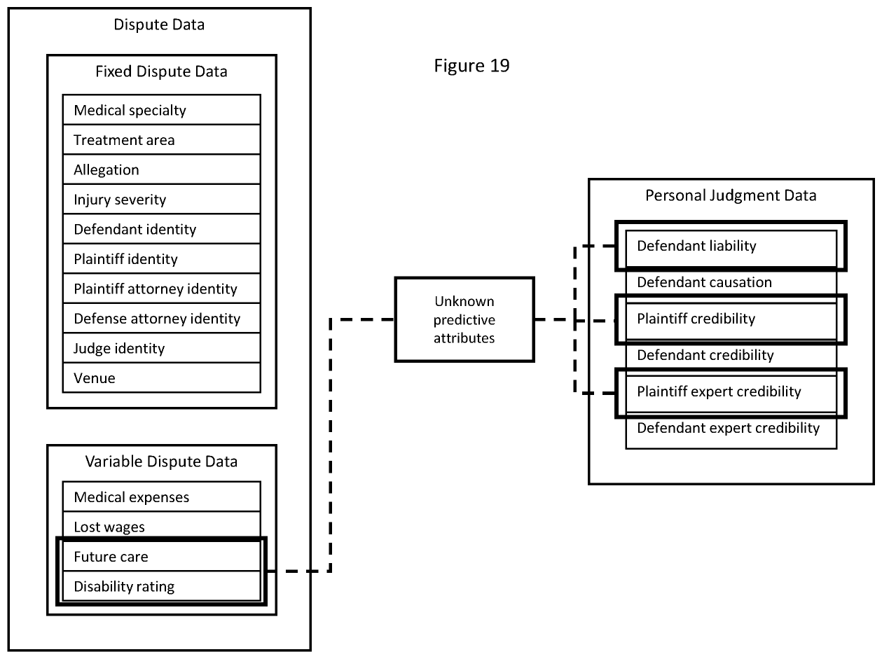

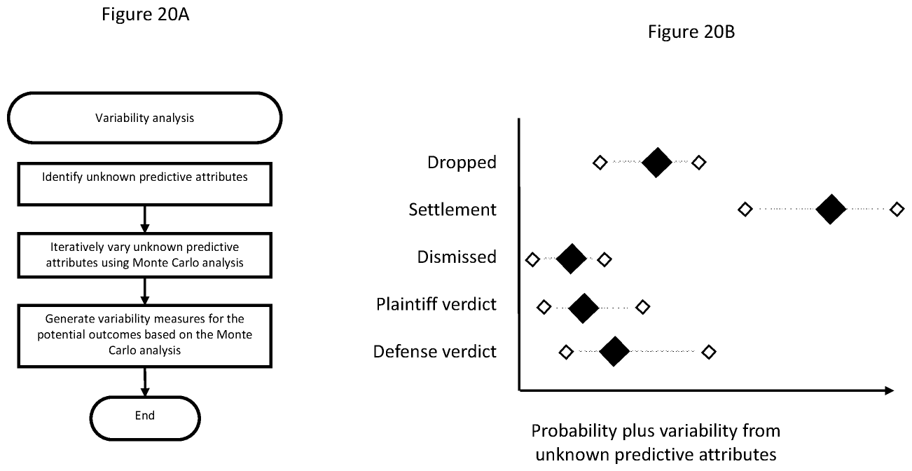

FIG. 19 illustrates how the variability analysis module shown in FIG. 3 can hold known predictive attributes fixed while varying unknown predictive attributes to generate variability measures as shown in FIG. 20B. The process for generating variability measures is illustrated in FIG. 20A. Variability measures could be generated by any statistical method known in the art, including Monte Carlo analysis.

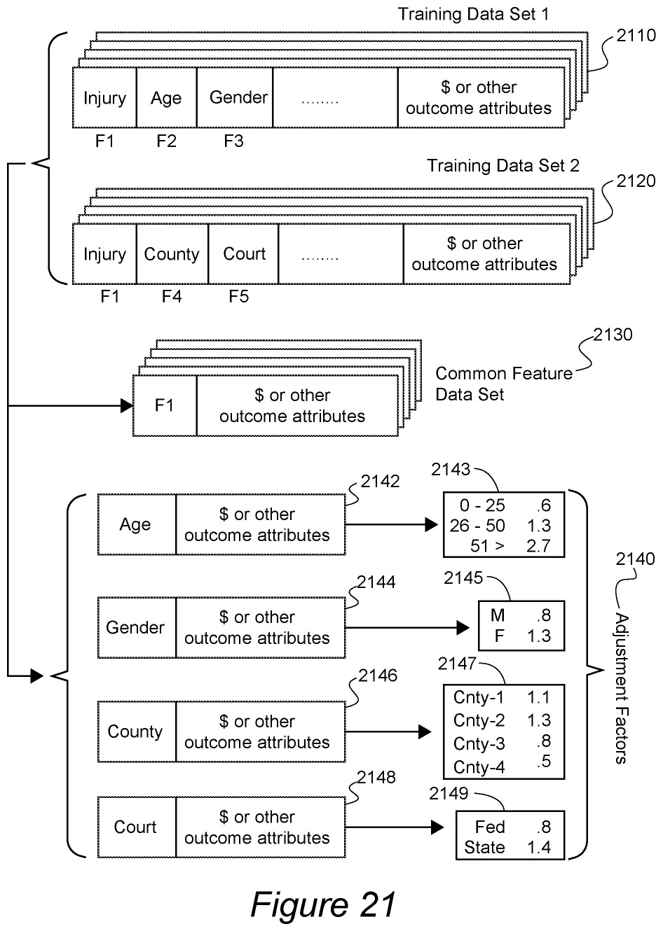

FIG. 21 is a schematic of an exemplary embodiment in the field of insurance cases, in which data from disparate training data sets 2110, 2120 are coordinated to provide training data to a machine learning model.

Training data set 2110 includes records having Injury, Age, Gender and other feature fields not specifically shown in the figure, and one or more outcome attribute fields. Training data set 2120 includes records having Injury, County, Court, other feature fields not specifically shown in the figure, and one or more outcome attribute fields. In this simplistic example, the only common feature field is Injury, however, it is contemplated that there could be multiple common feature fields.

Contemplated attribute outcome fields in training data sets 2110 and 2120 include any appropriate outcomes, including for example settlement, judgment or other monetary amounts, and percentage of cases being dropped, settled, litigated with monetary judgment, and litigated with a null judgement. Training data sets 2110 and 2120 can include multiple attribute outcome fields.

The data in training data sets 2110 and 2120 are referred to records above, although the term “records” should be interpreted broadly to include not only records of a typical flat table, but all other forms of correlated data, including for example, XML data formats. Training data sets 2110 and 2120 should be interpreted as having many records, in some case up to hundreds of thousands, or even millions of records.

Although FIG. 21 only shows two training data sets, 2110 and 2120, FIG. 21 should be interpreted as potentially including three, four, five, or any other reasonable number of data sets.

Common featured data set 2130 pulls data from the training data sets 2110 and 2120, and has at least one common feature, in this case feature F1, Injury. Common featured data set 2130 should be interpreted as having many records, in some case up to hundreds of thousands, or even millions of records.

Regression analysis is used to derive adjustment data sets from the training data sets. In this simplistic example, regression analysis is used to derive adjustment data sets 2142, 2144, 2146, 2148 from the data in training data sets 2110 and 2120. The derive adjustment data sets 2142, 2144, 2146, 2148 are then used to derive adjust factors 2140, in this case age adjustment factors 2143 from age adjustment data set 2142, gender adjustment factors 2145 from gender adjustment data set 2144, county adjustment factors 2147 from adjustment data sets 2146, and court adjustment factors 2149 from court adjustment data set 2148.

All appropriate manners of regression analysis are contemplated, and it should be appreciated that the term “regression analysis” should be interpreted herein to refer to any analytical techniques for inferring relationships between dependent and independent variables. it should also be appreciated that the adjustment factors 2143, 2145, 2147, and 2149 are merely presented for purposes of exemplification, and do not necessarily represent real-world factors.

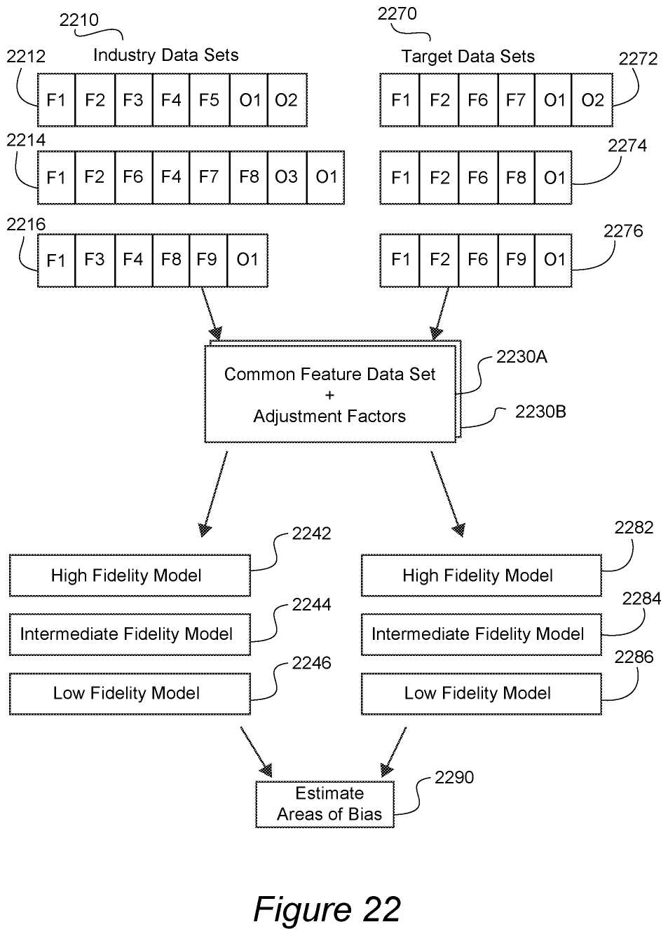

FIG. 22 is a schematic of an exemplary embodiment in which training data from disparate data sets are used to produce machine learning models of various predictive fidelity, and to estimate areas of bias.

In this example, multiple data sets 20212, 22214, and 2216 of Industry Data Sets 2210 are used to create a Common Feature Data Set and Adjustment Factors (collectively 2230A), along the lines of FIG. 21. Common Feature Data Set and Adjustment Factors 2230A are then used to create machine learning models of varying fidelity 2242, 2244, 2246.

The Industry Data Sets 2210 are shown as being a bit more complicated than the training Data Sets 2110, 2120 of FIG. 21, in having multiple common features. Features F1 and F4 are common to each of Data Sets 2212, 2214, and 2216, while Feature F2 is common to only Data Sets 2212 and 2214. FIG. 22 is also complicated in that outcome attribute O1 is common to each of Data Sets 2212, 2214, and 2216, while outcome attribute O2 and O3 are not common to multiple data sets.

Target data sets 2270 are used to create or augment the Common Feature Data Set and Adjustment Factors 2230A, and/or a Common Feature Data Set and Adjustment Factors (collectively 2230B), along the lines of FIG. 21. Common Feature Data Set and Adjustment Factors 2230A and/or 2230B are then used to create machine learning models of varying fidelity 2282, 2284, 2286. In this case features F1, F2, and F6 are all common to each of Target Data Sets 2272, 2274, 2276, as is outcome attribute O1.

Although Industry Data Sets 2210 only depicts the three data sets 2212, 2214, and 2216, with a relatively few number of data fields, Industry Data Sets 2210 should be interpreted as including any suitable number of data dets, each of which should be interpreted as having any suitable number of data fields. Target Data Sets 2270 should be interpreted along the same lines, to include any suitable number of data dets, each of which should be interpreted as having any suitable number of data fields

Data produced by one or more of machine learning models 2242, 2244, 2246 can be compared with data produced by one or more of machine learning models 2282, 2284, 2286 to detect areas of bias in the Target Data Sets 2270, and/or the machine learning models 2282, 2284, 2286.

Data produced by one or more of machine learning models 2242, 2244, 2246 can also be compared with data produced by one or more of machine learning models 2282, 2284, 2286 to extend the machine learning models 2282, 2284, 2286 to areas in which the Target Data Sets 2270 have limited or no data.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context.

What is claimed is:

1. A method of training and using a machine learning model, comprising using a computer processor and at least a first computer readable memory to:
instantiate a first training data set comprising correlations between outcome attribute and at least features F1, F2, and F3;
instantiate a second training data set comprising correlations between outcome attributes and at least features F1, F4, and F5;
instantiating a common feature data set comprising the correlations of feature F1 and outcome attributes from the first and second data sets;
apply regression modeling to data in the first training data set to calculate outcome adjustment features A2 and A3 for features F2 and F3, respectively;
apply regression modeling to data in the second training data set to calculate outcome adjustment features A4 and A5 for features F4 and F5, respectively;
train the machine learning model on the common feature data set and the outcome adjustment features A2, A3, A4, and A5;
apply the trained machine learning model to individual correlations of a target data set, to produce a target outcome model.

2. The method of claim 1, further comprising apply the trained machine learning model to individual correlations of a target data set, to produce (a) a relatively higher fidelity target outcome model, in which relatively fewer missing data elements are replaced by inferred data elements, and (b) a relatively lower fidelity target outcome model, in which relatively more missing data elements are replaced by inferred data elements.

3. The method of claim 1, further comprising applying the trained machine learning model to the individual correlations of the target data set, to produce an intermediate target fidelity outcome model, in which an intermediate number of missing data elements are replaced by inferred data elements.

4. The method of claim 1, further comprising applying the trained machine learning model to individual correlations of an industry data set, to produce an industry outcome model, and comparing the industry outcome model to the target outcome model.

5. The method of claim 1, further comprising applying the trained machine learning model to individual correlations of an industry data set, to produce an industry outcome model, and comparing the industry outcome model to the target outcome model to ascertain areas of bias in the target outcome model.

6. The method of claim 1, further comprising instantiating an enhanced data set using data from the target data set and data from an industry data set, and applying the trained machine learning model to individual correlations of the supplemented data set, to produce an enhanced outcome model.

7. The method of claim 1 wherein at least one of the outcome attributes is a probability.

8. The method of claim 1 wherein at least one of the outcome attributes is a monetary amount.
